(19) United States
(12) Patent Application Publication
(10) Pub. No.: US 2022/0356687 A1
(43) Pub. Date: Nov. 10, 2022

(54) GARBAGE DISPOSAL SYSTEM

(71) Applicant: Lines 5 MCM, LLC, Fredericksburg, TX (US)

(72) Inventor: Matthew M. Lines, Fredericksburg, TX (US)

(21) Appl. No.: 17/307,778

(22) Filed: May 4, 2021

(51) Int. Cl. E03C 1/266; B02C 18/00

(52) U.S. Cl. CPC E03C 1/2665; B02C 18/0092

(57) ABSTRACT

A garbage disposal system includes a garbage disposer, a switch box, a push button assembly, and an illumination source. The garbage disposer resides between a sink and a drain pipe. The switch box is electrically coupled to a power source and to the electric motor of the garbage disposer. The switch box includes a pneumatically-operable electrical switch that completes a circuit upon being triggered to power the electric motor. The push button assembly includes a pneumatic line coupled to the electrical switch and a button coupled to the pneumatic line. The button is accessible from above the sink. The push button assembly pneumatically activates the electrical switch upon the button being pushed, activating the electric motor. The illumination source is electrically coupled to the switch box and radiates light visible above the sink in response to the pneumatic activation of the electrical switch.

### FIELD OF THE DISCLOSURE

This disclosure relates to sink garbage disposers, in particular, to air switches of garbage disposers.

### BACKGROUND OF THE DISCLOSURE

Food waste disposers in sinks shred food and other garbage into small pieces to help prevent clogs in plumbing. Food waste disposers can be activated with an electrical switch located near the sink or with an air switch push button located on a kitchen countertop near the sink. Air switches can reduce the risk of electrical shock because the electrical switch is situated below the sink and activated by air pressure when the push button is pressed. Thus, air switches do not have current at the point of actuation, which reduces the risk of shock when activating the disposer with wet hands. Some food waste disposers are specifically designed to operate quietly, which can make it difficult for a user to know when the disposer is operating. Quiet food waste disposers can be a hazard because if a user forgets that the disposer is on, the user may reach into the disposer. Methods and equipment for safely operating food waste disposers are sought.

### SUMMARY

Implementations of the present disclosure include a garbage disposal system that includes a garbage disposer, a switch box, a push button assembly, and an illumination source. The garbage disposer resides between and is coupled to a sink and a drain pipe. The garbage disposer includes an electric motor and a shredding plate rotatable by the motor to shred garbage received from the sink. The garbage disposer flows the shredded garbage to the drain pipe. The switch box is electrically coupled to a power source. The switch box is electrically coupled to the electric motor of the garbage disposer. The switch box includes a pneumatically-operable electrical switch that completes a circuit upon being triggered to power the electric motor. The push button assembly includes a pneumatic line coupled to the pneumatically-operable electrical switch and a button coupled to the pneumatic line. The button is accessible from above the sink. The push button assembly pneumatically activates the electrical switch upon the button being pushed, activating the electric motor of the garbage disposer. The illumination source is electrically coupled to the switch box. The illumination source radiates light visible above the sink in response to the pneumatic activation of the electrical switch.

In some implementations, the switch box lowers a voltage received from the power source and transmits, upon activation of the electrical switch, electricity with the lowered voltage to the illumination source. In some implementations, the illumination source includes a low-voltage illumination source. The low-voltage illumination source includes an illumination ring disposed around or under the button. The illumination ring includes a translucent surface through which the low-voltage illumination source radiates light indicating that the garbage disposer is operating.

In some implementations, the switch box is electrically coupled to a low-voltage battery power source. The switch box transmits, upon activation of the electrical switch, electricity with a low voltage from the low-voltage battery power source to the illumination source.

In some implementations, the switch box simultaneously powers, upon activation of the electrical switch, the garbage disposer and the illumination source.

In some implementations, the switch box alternately activates and deactivates the illumination source and the garbage disposer upon being triggered by the push button assembly.

In some implementations, the switch box includes an electric port that interfaces with a power plug of the garbage disposer. The switch box transmits electricity to the garbage disposer through the power plug to power the garbage disposer.

In some implementations, the switch box powers the garbage disposer and the illumination source upon activation of the electrical switch until the electrical switch is triggered again by pushing the button of the push button assembly.

Implementations of the present disclosure include an air switch assembly that includes a push button assembly, an illumination source, and a switch box. The push button assembly includes a pneumatic line and a button coupled to the pneumatic line. The button is coupled to a surface above a countertop or a sink or both. The button is accessible from above the countertop or the sink or both. The illumination source is coupled to the surface above the countertop or the sink or both and is visible above the countertop or the sink or both. The switch box is electrically coupled to a power source and it includes a first electrical output. The switch box transmits electricity with a first voltage through the first electrical output to a garbage disposer attached to the sink. The switch box including a second electrical output and transmits electricity with a second voltage lower than the first voltage through the second electrical output to the illumination source. The switch box includes a pneumatically-operable electrical switch coupled to the pneumatic line. The pneumatically-operable electrical switch completes a circuit upon being moved by air pressure of the pneumatic line. With the electrical switch moved, the switch box transmits the electricity with the first voltage to the garbage disposer and the electricity with the second voltage to the illumination source.

In some implementations, the illumination source includes a low-voltage illumination source that radiates light visible above the countertop in response to the pneumatic activation of the electrical switch. In some implementations, the switch box steps down a voltage received from the power source. The switch box transmits, upon activation of the electrical switch, electricity at a lowered voltage to the illumination source. In some implementations, the switch box includes a low-voltage battery power source. The switch box transmits, upon activation of the electrical switch, electricity at a low voltage from the low-voltage battery power source to the illumination source. In some implementations, the low-voltage illumination source includes an illumination ring disposed around or under the button. The illumination ring radiates light indicating that the garbage disposer is operating.

In some implementations, the switch box simultaneously transmits, upon activation of the electrical switch, the electricity with the first voltage and the electricity with the second voltage to the garbage disposer and the illumination source respectively.

In some implementations, the first electrical output includes a first electric port that receives and electrically connects to a power cable of the garbage disposer. The switch box transmits the electricity at the first voltage to the garbage disposer through the power cable of the garbage disposer. In some implementations, the second electrical output includes a second electric port that receives and electrically connects to a power cable of the illumination source. The switch box transmits the electricity with the low voltage to the illumination source through the power cable of the illumination source.

In some implementations, the switch box continuously transmits the electricity with the first voltage and the electricity with the second voltage to the garbage disposer and the illumination source respectively upon activation of the electrical switch until the electrical switch is triggered again by the push button assembly.

Implementations of the present disclosure include a method of operating an air switch assembly. The method includes pushing a button to activate a garbage disposer attached to a sink and an illumination source of the air switch assembly. The air switch assembly includes a push button assembly, an illumination source, and a switch box. The push button assembly includes a pneumatic line and the button coupled to the pneumatic line. The button is coupled to a surface above the sink or a countertop or both and is accessible from above the sink or the countertop or both. The illumination source is coupled to the surface above the sink or the countertop or both and is visible above the sink or the countertop or both. The switch box is electrically coupled to a power source. The switch box includes a first electrical output that transmits electricity with a first voltage to the garbage disposer, and a second electrical output that transmits electricity with a second voltage lower than the first voltage to the illumination source. The switch box includes a pneumatically-operable electrical switch coupled to the pneumatic line. The electrical switch complete a circuit upon being pushed by air pressure of the pneumatic line created by pushing the button, thereby transmitting the electricity with the first voltage to the garbage disposer and the electricity with the second voltage to the illumination source. The method also includes releasing the button while the garbage disposer and the illumination source remain activated. The method also includes pushing the button to deactivate the garbage disposer and the illumination source.

In some implementations, the switch box simultaneously transmits, upon activation of the electrical switch, the electricity with the first voltage and the electricity with the second voltage to the garbage disposer and the illumination source respectively. Pushing the button to activate the garbage disposer and the illumination source includes simultaneously activating the garbage disposer and the illumination source. In some implementations, pushing the button to deactivate the garbage disposer and the illumination source includes simultaneously deactivating the garbage disposer and the illumination source.

Particular implementations of the subject matter described in this specification can be implemented so as to realize one or more of the following advantages. For example, the illumination source next to the air switch button creates a visual indication that the garbage disposer is on, which can help prevent accidents. Additionally, the low voltage source of the illumination source can help indicate operation of the garbage disposer while still prevent shock when pressing the button with wet hands.

### BRIEF DESCRIPTION OF THE DRAWINGS

FIG. 1 is a schematic view of a garbage disposal system.

FIG. 2 is a perspective schematic view of a switch box of the garbage disposal system in FIG. 1.

FIG. 3 is a schematic diagram of a circuit of the switch box according to a first implementation of the present disclosure.

FIG. 4 is a schematic diagram of a circuit of the switch box according to a second implementation of the present disclosure.

FIG. 5 is a flow chart of an example method of using an air switch assembly.

### DETAILED DESCRIPTION OF THE DISCLOSURE

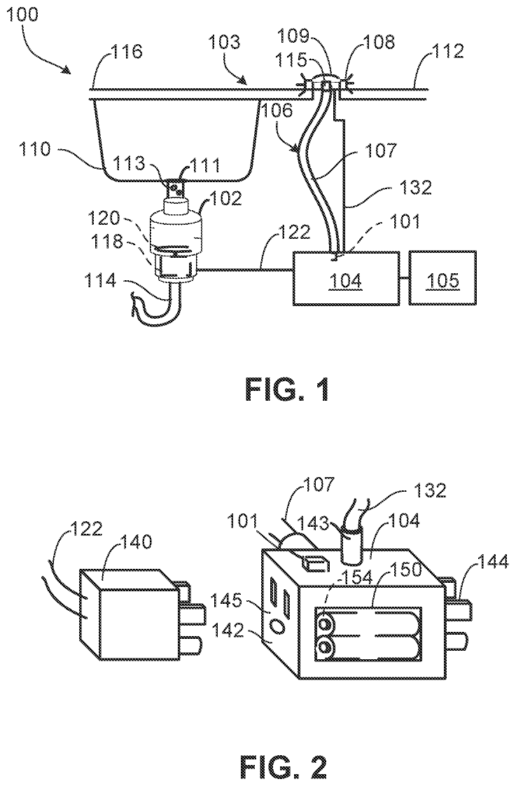

FIG. 1 depicts a garbage disposal system 100 with an illumination source 108 (e.g., a low-voltage illumination source) that indicates when the garbage disposal system 100 is operating. The garbage disposal system 100 includes a garbage disposer 102, a switch box 104, a push button assembly 106, and the illumination source 108. The push button assembly 106, the illumination source 108, and the switch box 104 can be part of an air switch assembly 103. The switch box 104 receives electrical power from a power source 105 (e.g., a breaker box connected to a utility pole) and transmits the power to the garbage disposer 102 and to the illumination source 108, allowing a person using a sink 110 to know when the garbage disposer 102 is operating.

The sink 110 can be any type of sink such as a kitchen sink. The sink 110 is attached to a countertop 112. For example, the sink 110 can be attached to the countertop 112 with the sink 110 positioned below a top surface 116 of the countertop. The sink 110 has a drain 111 through which water and waste food or other garbage 113 flows into the garbage disposer 102.

The garbage disposer or garbage disposal unit 102 is located between the sink drain 111 and a drain pipe 114 (e.g., sink plumbing such as a P-trap). The garbage disposer 102 receives the garbage 113 from the sink 110 and shreds the garbage 113 before the garbage 113 reaches the drain pipe 114. The garbage disposer 102 has an electric motor 118 and a shredding plate or blade 120. The motor 118 rotates the shredding plate 120 to shred the garbage 113 received from the sink 110. The garbage disposer 102 flows or allows the shredded garbage to move to the drain pipe 114. The garbage disposer 102 is electrically coupled, through a cable 122, to the switch box 104.

The switch box 104 can be a power control module or any type of electrical box that receives an input voltage and has one or two power outputs. For example, the switch box 104 can receive a electricity at a first voltage from the power source 105 and transmit electricity at the first voltage (or a different voltage) to the garbage disposer 102. The switch box 104 also converts the voltage of the electricity from the power source 105 into a low voltage and transmits the low-voltage electricity to the illumination source. For example, the low-voltage electricity can have a second voltage that is less than the first voltage. The second voltage or low voltage can be, for example, between 1 to 15 volts (e.g., 9 volts). In some implementations, the switch box 104 transmits electricity with the same voltage to the illumination source 108 as the voltage of the electricity transmitted to the garbage disposer 102.

The switch box 104 is electrically coupled to the electric motor 118 of the garbage disposer 102 through cable 122. In some cases, the switch box may be physically mounted to, or part of, garbage disposer 102. The switch box 104 is electrically coupled to the illumination source 108 through a second electrical cable 132. The switch box has a pneumatically-operable electrical switch 101 (e.g., an air switch) that completes a circuit of the switch box 104 upon being triggered. When the switch 101 is triggered, the switch box 104 either activates or deactivates the electric motor 118 and the illumination source 108.

The push button assembly 106 includes a pneumatic line 107 and a push button 109 coupled to pneumatic line 107. The button 109 is accessible from above the sink 110. For example, the button 109 can be attached to a surface above the sink 110, which includes any surface at or near the sink such as the countertop 112, a wall, or a different surface that is accessible to a user standing at the sink 110. The pneumatic line 107 is attached to the switch box 104 to deliver a pressurized air to the switch 101 to flip the switch. When the button 109 is pushed, the compressed air inside the pneumatic tube 107 increases in pressure (or flow rate), which trips the switch 101 to turn on the disposer 102 and light 108. A subsequent increase of pressure or flow caused by pressing the button 108 a second time trips the switch 101 again in the opposite direction, turning off the disposer 102 and light 108. For example, a diaphragm inside the tube can be compressed when the bottom is pushed down to momentarily pressurize the air in the tube. In some implementations, the button can have 109 a cylinder 115 disposed inside the pneumatic line 107, and pressing the button 109 pushes the cylinder 115, which pressurizes the air inside the pneumatic line to flip the switch 101.

The illumination source 108 can be a low-voltage illumination source such as one or more light-emitting diodes (LED). The low-voltage illumination source can be placed next to, around, under, or otherwise near the button 109 above the sink 110. For example, the illumination source 108 can be in the form of an illumination ring disposed around the button 109. The illumination ring can be placed above the countertop 112 or flush with the countertop 112. The illumination ring can have a translucent surface through which the low-voltage illumination source radiates light indicating that the switch is active (i.e., that garbage disposer 102 is operating). The light is visible above the sink and can be a red light to warn the user and prevent the user from reaching into the garbage disposer 102. The illumination source 108 is activated (e.g., radiates light) in response to the pneumatic activation of the electrical switch 101.

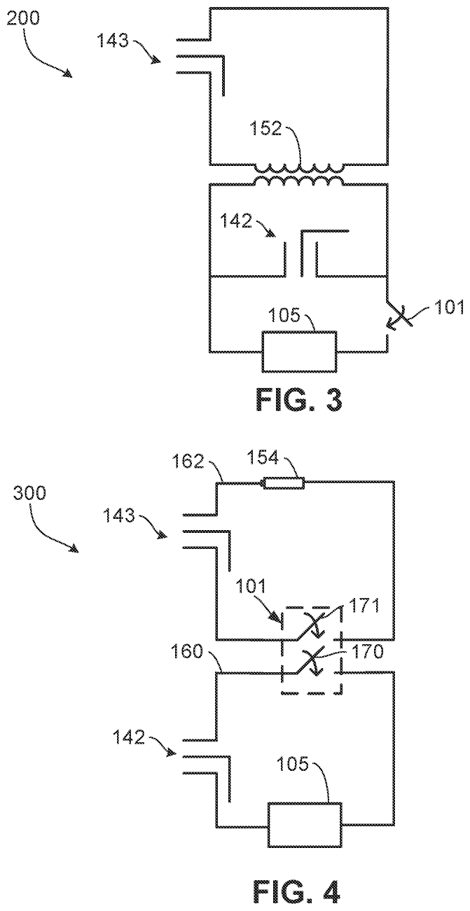

Referring also to FIG. 2, the switch box 104 has a first electrical output 142 and a second electrical output 143. The first electrical output 142 transmits electricity with a first voltage to a garbage disposer 102 and the second electrical output 143 transmits electricity with a second voltage lower than the first voltage to the illumination source 108. As further described in detail below with respect to FIGS. 3 and 4, to send low-voltage electricity to the illumination source 108, the switch box 104 can rely on a 1) transformer to lower the voltage received from the power source 105, or 2) one or more low-voltage batteries 154 (e.g., AAA batteries). The switch box 104 can have a battery compartment 150 that accommodates the batteries 154 or can be electrically coupled to a battery compartment outside the switch box 104. The electrical switch 101 completes a circuit upon being pushed or otherwise moved by air pressure of the pneumatic line 107 to transmit the electricity with the first voltage to the garbage disposer 102 and the electricity with the second voltage to the illumination source 108.

The first electrical output 142 can include an electric port or socket 145 that electrically connects to the power cable 122 of the garbage disposer 102. For example, the socket 145 receives a power plug 140 of the power cable 122. Specifically, the switch box 104 can include a piggyback plug that connects to a power source and receives the plug of the electric motor 118. The second electrical output 134 can include an electric port and can be permanently or releasably coupled to the power cable 132 of the illumination source 108. For example, the power cord 132 can be soldered to an internal circuit of the switch box 104 or the switch box 104 can have a second socket that releasably receives a power plug of the illumination source 108. Thus, as further described in detail below with respect to FIG. 3, upon the triggering of the switch 101, the switch box 104 transmits electricity to the motor 118 through the power cable 122 of the motor 118 and transmits electricity to the illumination source 108 through the power cable 132 of the illumination source 108. In some implementations, the switch box 104

The switch box 104 simultaneously powers, upon activation of the electrical switch 101, the garbage disposer 102 and the illumination source 108. The switch box 104 alternately activates and deactivates the illumination source 108 and the garbage disposer 102 upon being triggered by the push button assembly 106. For example, when the button 109 is pressed and the electrical switch 101 is triggered, the switch box transmits electricity at a first voltage to the electric motor 118 and electricity at a second voltage lower than the first voltage to the illumination source 108. The switch box 104 is configured to continuously transmit the electricity with the first voltage and the electricity with the second voltage to the garbage disposer 102 and the illumination source 108 respectively upon activation of the electrical switch 101 until the electrical switch 101 is triggered again by the push button assembly 106. For example, pushing and releasing the button 109 activates the garbage disposer 102 and the illumination source 108 until the button 109 is pushed and released again.

FIG. 3 is a schematic diagram of an electric circuit 200 of the switch box 104 according to a first implementation. The circuit 200 includes power source 105, a transformer 152, electrical switch 101, first electrical output 142, and second electrical output 143. The transformer 152 transforms or steps down the voltage from the power source 105 so that the voltage at the second electrical output 143 is a lower voltage than the primary side of the transformer 152. The electrical output 142 can be arranged in parallel with the transformer 152, allowing the electrical output 142 to output substantially the same voltage by the switch box from the power source 105. The switch 101 can be disposed between the electrical output 142 and the transformer 152. The pneumatic line moves the switch 101 to close the circuit 200 and provide electricity to the electric motor and the illumination source. The input from the power source 105 can be an alternating current with a voltage of about 110 V or 120 V. The voltage at the first electrical output 142 can be the same or different voltage. The output at the second electrical output 143 can be a direct current and have a voltage of about 1 V to 15 V (e.g., 9 V).

FIG. 4 is a schematic diagram of an electric circuit 300 of the switch box 104 according to a second implementation. The circuit 300 includes power source 105, one or more batteries 154, electrical switch 101, first electrical output 142, and a second electrical output 143. The one or more batteries 154 produce a low voltage (e.g., 1.5, 3, or 9 V each) so that the voltage at the second electrical output 143 is, for example, between 3 V and 10 V. The switch 101 can complete two separate or isolated circuits 160 and 162 disposed side by side that are simultaneously activated by the push button assembly 106. For example, the switch 101 can include two pneumatically-operable switches or the switch 101 can be a switch (e.g., a double pole single throw switch) with two contacts 170 and 171 that control or complete the two separate circuits 160 and 162. The first contactor 170 completes the circuit 160 of the first electrical output 142 and the second contactor 171 completes the circuit 162 of the second electrical output 143. The pneumatic line moves the switch 101 (or switches) to provide electricity to the electric motor and the illumination source.

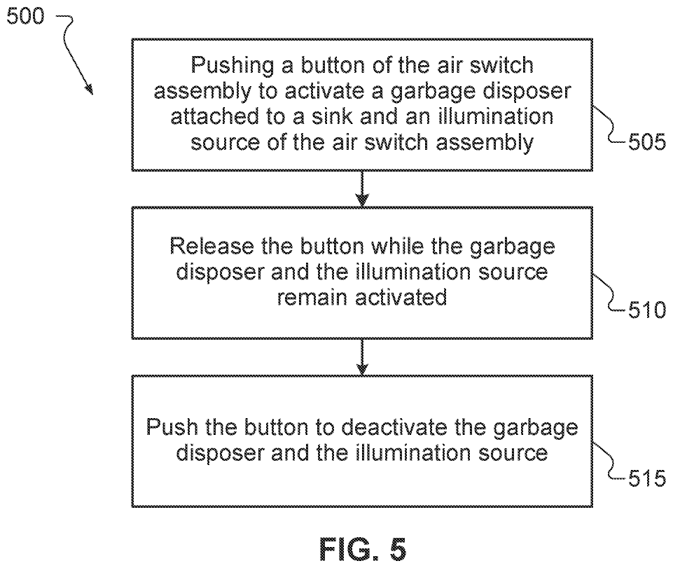

FIG. 5 shows a flow chart of an example method 500 of operating an air switch assembly. The method includes pushing a button of the air switch assembly to activate a garbage disposer attached to a sink and an illumination source of the air switch assembly (505). The method also includes releasing the button while the garbage disposer and the illumination source remain activated (510). The method also includes pushing the button again to deactivate the garbage disposer and the illumination source (515).

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A garbage disposal system, comprising:
a garbage disposer residing between and coupled to a sink and a drain pipe, the garbage disposer comprising an electric motor and a shredding plate rotatable by the motor to shred garbage received from the sink, the garbage disposer configured to flow the shredded garbage to the drain pipe;
a switch box electrically coupled to a power source, the switch box electrically coupled to the electric motor of the garbage disposer, the switch box comprising a pneumatically-operable electrical switch configured to complete a circuit upon being triggered to power the electric motor;
a push button assembly comprising a pneumatic line coupled to the pneumatically-operable electrical switch and a button coupled to the pneumatic line and accessible from above the sink, the push button assembly configured to pneumatically activate the electrical switch upon the button being pushed, activating the electric motor of the garbage disposer; and
an illumination source electrically coupled to the switch box, the illumination source configured to radiate light visible above the sink in response to the pneumatic activation of the electrical switch.

2. The garbage disposal system of claim 1, wherein the switch box is configured to lower a voltage received from the power source and transmit, upon activation of the electrical switch, electricity with the lowered voltage to the illumination source.

3. The garbage disposal system of claim 2, wherein the illumination source comprises a low-voltage illumination source, the low-voltage illumination source comprising an illumination ring disposed around or under the button, the illumination ring comprising a translucent surface through which the low-voltage illumination source radiates light indicating that the garbage disposer is operating.

4. The garbage disposal system of claim 1, wherein the switch box is electrically coupled to a low-voltage battery power source and is configured to transmit, upon activation of the electrical switch, electricity with a low voltage from the low-voltage battery power source to the illumination source.

5. The garbage disposal system of claim 1, wherein the switch box is configured to simultaneously power, upon activation of the electrical switch, the garbage disposer and the illumination source.

6. The garbage disposal system of claim 1, wherein the switch box is configured to alternately activate and deactivate the illumination source and the garbage disposer upon being triggered by the push button assembly.

7. The garbage disposal system of claim 1, wherein the switch box comprises an electric port configured to interface with a power plug of the garbage disposer, the switch box configured to transmit electricity to the garbage disposer through the power plug to power the garbage disposer.

8. The garbage disposal system of claim 1, wherein the switch box is configured to power the garbage disposer and the illumination source upon activation of the electrical switch until the electrical switch is triggered again upon the button of the push button assembly being pushed.

9. An air switch assembly, comprising:
a push button assembly comprising a pneumatic line and a button coupled to the pneumatic line, the button configured to be coupled to a surface above a countertop attached to a sink, the button accessible from above the countertop;
an illumination source configured to be coupled to the surface above the countertop and visible above the countertop; and
a switch box configured to be electrically coupled to a power source, the switch box comprising a first electrical output and configured to transmit electricity with a first voltage through the first electrical output to a garbage disposer attached to the sink, the switch box comprising a second electrical output and configured to transmit electricity with a second voltage lower than the first voltage through the second electrical output to the illumination source, the switch box comprising a pneumatically-operable electrical switch coupled to the pneumatic line and configured to complete a circuit upon being moved by air pressure of the pneumatic line to transmit the electricity with the first voltage to the garbage disposer and the electricity with the second voltage to the illumination source.

10. The air switch assembly of claim 9, wherein the illumination source comprises a low-voltage illumination source configured to radiate light visible above the countertop in response to the pneumatic activation of the electrical switch.

11. The air switch assembly of claim 10, wherein the switch box is configured to step down a voltage received from the power source and transmit, upon activation of the electrical switch, electricity at a lowered voltage to the illumination source.

12. The air switch assembly of claim 10, wherein the switch box comprises a low-voltage battery power source and is configured to transmit, upon activation of the electrical switch, electricity at a low voltage from the low-voltage battery power source to the illumination source.

13. The air switch assembly of claim 10, wherein the low-voltage illumination source comprises an illumination ring disposed around or under the button, the illumination ring configured to radiate light indicating that the garbage disposer is operating.

14. The air switch assembly of claim 9, wherein the switch box is configured to simultaneously transmit, upon activation of the electrical switch, the electricity with the first voltage and the electricity with the second voltage, to the garbage disposer and the illumination source respectively.

15. The air switch assembly of claim 9, wherein the first electrical output comprises a first electric port configured to receive and electrically connect to a power cable of the garbage disposer, the switch box configured to transmit the electricity at the first voltage to the garbage disposer through the power cable of the garbage disposer.

16. The air switch assembly of claim 15, wherein the second electrical output comprises a second electric port configured to receive and electrically connect to a power cable of the illumination source, the switch box configured to transmit the electricity with the low voltage to the illumination source through the power cable of the illumination source.

17. The air switch assembly of claim 9, wherein the switch box is configured to continuously transmit the electricity with the first voltage and the electricity with the second voltage to the garbage disposer and the illumination source upon activation of the electrical switch until the electrical switch is triggered again by the push button assembly.

18. A method of operating an air switch assembly, the method comprising:
pushing a button to activate a garbage disposer and an illumination source of the air switch assembly, the garbage disposer attached to a sink, the air switch assembly comprising,
a push button assembly comprising a pneumatic line and the button coupled to the pneumatic line, the button coupled to a surface above a countertop attached to the sink, the button accessible from above the countertop;
an illumination source coupled to the surface above the countertop and visible above the countertop; and
a switch box electrically coupled to a power source, the switch box comprising a first electrical output configured to transmit electricity with a first voltage to the garbage disposer, and a second electrical output configured to transmit electricity with a second voltage lower than the first voltage to the illumination source, the switch box comprising a pneumatically-operable electrical switch coupled to the pneumatic line and configured to complete a circuit upon being pushed by air pressure of the pneumatic line created by pushing the button, thereby transmitting the electricity with the first voltage to the garbage disposer and the electricity with the second voltage to the illumination source; and
releasing the button while the garbage disposer and the illumination source remain activated; and
pushing the button to deactivate the garbage disposer and the illumination source.

19. The method of claim 18, wherein the switch box is configured to simultaneously transmit, upon activation of the electrical switch, the electricity with the first voltage and the electricity with the second voltage to the garbage disposer and the illumination source respectively, and pushing the button to activate the garbage disposer and the illumination source comprises simultaneously activating the garbage disposer and the illumination source.

20. The method of claim 19, wherein pushing the button to deactivate the garbage disposer and the illumination source comprises simultaneously deactivating the garbage disposer and the illumination source.
